(19) United States
(12) Patent Application Publication
(10) Pub. No.: US 2014/0335451 A1
(43) Pub. Date: Nov. 13, 2014

(54) TONER PARTICLES HAVING AN INCREASED SURFACE HARDNESS AND TONERS THEREOF

(71) Applicant: XEROX CORPORATION, Norwalk, CT (US)

(72) Inventors: Joo T. Chung, Webster, NY (US); Jay L. Schneider, Canandaigua, NY (US); Chieh-Min Cheng, Rochester, NY (US); Christopher Wolfe, Rochester, NY (US); Angela Schnuerch, Naples, NY (US)

(73) Assignee: XEROX CORPORATION, Norwalk, CT (US)

(21) Appl. No.: 13/890,152

(22) Filed: May 8, 2013

(51) Int. Cl. G03G 9/093

(52) U.S. Cl. CPC G03G 9/09328
USPC 430/110.2

(57) ABSTRACT

The present embodiments relate to toner particles having an increased surface hardness, and toners comprising said toner particles. More specifically, the present embodiments relate to toner particles having an average surface hardness of from about 130 mPa to about 250 mPa, comprising a core surrounded by a shell, wherein the shell comprises a crystalline resin.

### INTRODUCTION

The present disclosure generally relates to toner particles having an increased surface hardness and toner compositions comprising said toner particles.

Xerographic toners are typically blended with additives for adhesion control in development and transfer processes. Surface additives are used to space toners away from the electrode surfaces, thereby lowering adhesion forces. However, in a developer housing, additives get buried into the toner over time due to the repeated mechanical stresses encountered. This is referred to as toner aging. Aged toners can have significantly higher adhesion forces, and often perform poorly in development and transfer. Aged toners often lose their xerographic functionality, such as, control of toner flow, charge level, and rate of charge to prevent charge through or slow admix, which causes background.

Toner triboelectric charge and stability of triboelectric charge are important to enabling good printing image quality (e.g., consistent image quality and color stability). Toners, such as, emulsion aggregate toners, were prepared by a process of controlled aggregation of latex, pigment and wax dispersions, in which polymer, pigment or wax particles are stabilized by surfactants and dispersed in an aqueous media. The process is initially prepared by mixing the toner components in water and adding a metal halide coagulant followed by heating. When the aggregates approach the required size, growth is stopped through caustic addition. The slurry of toner sized aggregates is then heated above the resin's Tg to coalesce the aggregates into discrete toner particles. Once the toner particles have the desired shape, the toner slurry is cooled to an appropriate working temperature (e.g., at about 30° C.). The resulting particles are then washed and dried.

Thus, efforts should be made to maintain the toner tribo level and tribo stability over the aging of toner inside the development system of the machine. One of such efforts is to maintaining the adherence of the additives on the surface of toner particle. As the hardness on the toner particle surface plays a role in governing the aged toner xerographic performance. One solution to the toner aging problem is to increase the hardness of the toner particle surface thereby minimizing or eliminating the additive embedment during the aging process. Thus, there is a need to provide toner particles having a hard surface, and a need to reduce the rate of toner aging without increasing the toner glass transition temperature (Tg).

### SUMMARY

According to embodiments illustrated herein, there is provided a toner particle having an increased surface hardness comprising a core surrounded by a shell, wherein the shell comprises a first crystalline resin, further wherein the toner particle has an average surface hardness of from about 130 mPa to about 250 mPa.

In particular, the present embodiments provide a toner particle having an increased surface hardness comprising a core surrounded by a shell, wherein the shell comprises a first crystalline polyester resin present in an amount of from about 15% to about 35% based on the total weight of the shell, and the core comprises a second crystalline polyester resin present in an amount of from about 10% to about 20% based on the total weight of the core, wherein the first crystalline polyester resin and the second crystalline polyester resin are the same, and further wherein the toner particle has an average surface hardness of from about 130 mPa to about 250 mPa.

The present embodiments also provide a toner composition comprising a toner particle having an increased surface hardness; and a colorant; wherein the toner particle comprising a core surrounded by a shell, wherein the shell comprises a first crystalline resin, wherein the toner particle has an average surface hardness of from about 130 mPa to about 250 mPa.

### BRIEF DESCRIPTION OF THE DRAWINGS

For a better understanding of the present embodiments, reference may be made to the accompanying figures.

FIG. 1 is a bar chart showing the hardness of the Control Toner and the Experimental Toner according to embodiments of the present disclosure.

### DETAILED DESCRIPTION

In the following description, it is understood that other embodiments may be utilized and structural and operational changes may be made without departure from the scope of the present embodiments disclosed herein.

As used herein, the singular forms “a”, “and,” and “the” include plural referents unless the context clearly indicates otherwise.

The present embodiments are directed generally to methods of increasing the surface hardness of a toner particle.

The disclosure applies the unique property of the crystalline resin on the surface (i.e., shell) of a toner particle for reinforcement of surface hardness to prevent additives from embedment.

Typically, the melting point of the crystalline resin according to the present disclosure is higher than the temperature inside of a developer housing (e.g., Pinot developer housing). The Pinot developer housing normally runs from about 40° C. to about 50° C., or at about 45° C. Below the melting point, the crystalline resin exhibits strong mechanical surface hardness, such as from about 170 MPa to about 190 MPa. Thus, including a crystalline resin in the shell of a toner particle may enforce the surface hardness of the toner particle.

The existing commercial toners on the market only contain amorphous resins on the surface of the tone particles. These amorphous resins may exhibit weak mechanical strength due to their lower glass transition temperature. A typical amorphous resin employed on the surface of a toner particle usually range from about 50° C. to about 58° C., or at about 57° C., which is closer to the temperature inside of a developer housing as compared to that of the crystalline resin.

The disclosure provides a toner particle comprises a core surrounded by a shell, wherein the shell comprises a first crystalline resin. In embodiments, the shell comprises a first crystalline resin and the core comprises a second crystalline resin. The first crystalline resin and the second crystalline resin may be the same or different.

In embodiments, the polymer utilized to form the crystalline resin according to embodiments of the present disclosure (including first crystalline resin and/or second crystalline resin) may be a polyester resin. Suitable polyester resins include, for example, sulfonated, non-sulfonated, crystalline, amorphous, combinations thereof, and the like. The polyester resins may be linear, branched, combinations thereof, and the like. Polyester resins may include, in embodiments, those resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

Crystalline Resin

In embodiments, the crystalline resin may be a polyester resin formed by reacting a diol with a diacid or diester in the presence of an optional catalyst. For forming a crystalline polyester, suitable organic diols include aliphatic diols having from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, ethylene glycol, combinations thereof, and the like. The aliphatic diol may be, for example, selected in an amount of from about 40 to about 60 mole percent, in embodiments from about 42 to about 55 mole percent, in embodiments from about 45 to about 53 mole percent of the resin.

Examples of organic diacids or diesters selected for the preparation of the crystalline resins include oxalic acid, succinic acid, glutaric acid, adipic acid, suberic acid, azelaic acid, fumaric acid, maleic acid, dodecanedioic acid, sebacic acid, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof, and combinations thereof. The organic diacid may be selected in an amount of, for example, in embodiments from about 40 to about 60 mole percent, in embodiments from about 42 to about 55 mole percent, in embodiments from about 45 to about 53 mole percent.

Examples of crystalline resins include polyesters, alkali containing copolymer, polyamides, polyimides, polyolefins, polyethylene, polybutylene, polyisobutyrate, ethylene-propylene copolymers, ethylene-vinyl acetate copolymers, polypropylene, mixtures thereof, and the like.

Specific examples of crystalline polyester include poly(ethylene-adipate), polypropylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), alkali copoly(5-sulfoisophthaloyl)-copoly(ethylene-adipate), poly(decylene-sebacate), poly(decylene-decanoate), poly-(ethylene-decanoate), poly-(ethylene-dodecanoate), poly(nonylene-sebacate), poly (nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), and combinations thereof.

In one embodiment, the crystalline polyester includes poly-(1,9-nonane diol-1,10-dodecane dicarboxylate.

Specific examples of alkali containing copolymer include alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium.

Specific examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinamide), and poly(propylene-sebecamide).

Specific examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The total amount of crystalline resin may be present, for example, in an amount of from about 5 to about 50 percent by weight of the toner composition, in embodiments from about 10 to about 35 percent by weight of the toner components.

The first crystalline resin may be present, for example, in an amount of from about 15 to about 35 percent by weight of the shell, in embodiments from about 22 to about 27 percent by weight of the shell.

The second crystalline resin may be present, for example, in an amount of from about 10 to about 20 percent by weight of the core, in embodiments from about 13 to about 18 percent by weight of the core.

The crystalline resin can possess various melting points of, for example, from about 30° C. to about 120° C., in embodiments from about 50° C. to about 90° C., or from about 60° C. to 80° C. The crystalline resin may have a number average molecular weight (Mn), as measured by gel permeation chromatography (GPC) of, for example, from about 1,000 to about 50,000, in embodiments from about 2,000 to about 25,000. The crystalline resin may have a weight average molecular weight (Mw) of, for example, from about 2,000 to about 100,000 as determined by Gel Permeation Chromatography using polystyrene standards. The molecular weight distribution (Mw/Mn) of the crystalline resin may be, for example, from about 2 to about 6, in embodiments from about 3 to about 4.

Amorphous Resin

In embodiments, the shell of a toner particle comprises a first amorphous resin. In embodiments, the core of a toner particle comprises a second amorphous resin. The first amorphous resin and the second amorphous resin may be the same or different.

The molecular weight of the amorphous resin correlates to the melt viscosity or acid value of the material. The weight average molecular weight (Mw) and molecular weight distribution (MWD) of the latex may be measured by Gel Permeation Chromatography (GPC). The molecular weight may be from about 3,000 g/mole to about 150,000 g/mole, including from about 8,000 g/mole to about 100,000 g/mole, and in more particular embodiments from about 10,000 g/mole to about 90,000 g/mole.

Examples of amorphous resins include poly(styrene-acrylate) resins, crosslinked, for example, from about 25 percent to about 70 percent, poly(styrene-acrylate) resins, poly(styrene-methacrylate) resins, crosslinked poly(styrene-methacrylate) resins, poly(styrene-butadiene) resins, crosslinked poly(styrene-butadiene) resins, alkali sulfonated-polyester resins, branched alkali sulfonated-polyester resins, alkali sulfonated-polyimide resins, branched alkali sulfonated-polyimide resins, alkali sulfonated poly(styrene-acrylate) resins, crosslinked alkali sulfonated poly(styrene-acrylate) resins, poly(styrene-methacrylate) resins, crosslinked alkali sulfonated-poly(styrene-methacrylate) resins, alkali sulfonated-poly(styrene-butadiene) resins, and crosslinked alkali sulfonated poly(styrene-butadiene) resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulf-o-isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), and wherein the alkali metal is, for example, a sodium, lithium or potassium ion.

Other examples of suitable amorphous resins or polymers which may be produced include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), polystyrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), and poly(styrene-butyl acrylate-acrylonitrile-acrylic acid), and combinations thereof. The polymer may be block, random, or alternating copolymers.

Polycondensation catalysts which may be utilized for either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include amorphous polyester resins. Exemplary amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), a copoly(propoxylated bisphenol A co-fumarate)-copoly(propoxylated bisphenol A co-terephthalate), a terpoly(propoxylated bisphenol A co-fumarate)-terpoly(propoxylated bisphenol A co-terephthalate)-terpoly-(propoxylated bisphenol A co-dodecylsuccinate), and combinations thereof.

The molecular weight of the amorphous resins correlates to the melt viscosity or acid value of the material. The weight average molecular weight (Mw) and molecular weight distribution (MWD) of the latex may be measured by Gel Permeation Chromatography (GPC). The molecular weight may be from about 3,000 g/mole to about 150,000 g/mole, including from about 8,000 g/mole to about 100,000 g/mole, and in more particular embodiments from about 10,000 g/mole to about 90,000 g/mole.

In embodiments, the second amorphous resin utilized in the core may be linear.

In embodiments, the resin may be formed by emulsion aggregation methods. Utilizing such methods, the resin may be present in a resin emulsion, which may then be combined with other components and additives to form a toner of the present disclosure.

The total polymer resin (crystalline resin and amorphous resin) may be present in an amount of from about 65 to about 95 percent by weight, such as from about 75 to about 85 percent by weight of the toner particles (that is, toner particles exclusive of external additives) on a solids basis.

In embodiments, the ratio of first crystalline resin to first amorphous resin in the shell can be from about 1:99 to about 30:70, such as from about from about 15:85 to about 25:75, in some embodiments from about 5:95 to about 15:95.

In embodiments, the ratio of second crystalline resin to second amorphous resin in the core can be from about 1:99 to about 30:70, such as from about 5:95 to about 25:75, in some embodiments from about 15:85 to about 25:75.

The toner particles of the present disclosure can be an emulsion aggregation tone particle, or other toners containing smaller toner particles, such as from about 3 micron to about 8 micron.

U.S. patents describing emulsion aggregation toners include, for example, U.S. Pat. Nos. 5,370,963, 5,418,108, 5,290,654, 5,278,020, 5,308,734, 5,344,738, 5,403,693, 5,364,729, 5,346,797, 5,348,832, 5,405,728, 5,366,841, 5,496,676, 5,527,658, 5,585,215, 5,650,255, 5,650,256, 5,501,935, 5,723,253, 5,744,520, 5,763,133, 5,766,818, 5,747,215, 5,827,633, 5,853,944, 5,804,349, 5,840,462, and 5,869,215, which are hereby incorporated by reference in its entirety.

The toner particles of the present disclosure have a core-shell structure. Once the core is formed and aggregated to a desired size, an outer shell is then formed upon the core. The core may comprise a crystalline resin, a amorphous reins, a colorant, a wax, or mixtures thereof. The shell may comprise a first crystalline resin the same as or different from the second crystalline resin used in the core. The shell components may be added to the core toner particle aggregates in an amount of about 5 to about 20 percent by weight of the total binder materials, for example in an amount of about 5 to about 13 percent by weight of the total binder materials. The shell or coating on the toner aggregates may have a thickness of about 0.2 to about 1.5 μm, for example of about 0.5 to about 1.0 μm.

The total amount of binder, including core and shell if present, may comprise an amount of from about 60 to about 95% by weight of the toner particles (i.e., toner particles exclusive of external additives) on a solids basis, such as from about 70 to about 90% by weight of the toner.

In preparing the toner by the emulsion aggregation procedure, one or more surfactants may be used in the process. Suitable surfactants include anionic, cationic and nonionic surfactants.

Anionic surfactants include sodium dodecylsulfate (SDS), sodium dodecyl benzene sulfonate, sodium dodecylnaphthalene sulfate, dialkyl benzenealkyl, sulfates and sulfonates, abitic acid, the DOWFAX brand of anionic surfactants, and the NEOGEN brand of anionic surfactants. An example of an anionic surfactant is NEOGEN RK available from Daiichi Kogyo Seiyaku Co. Ltd., which consists primarily of branched sodium dodecyl benzene sulphonate.

Examples of cationic surfactants include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C12, C15, C17 trimethyl ammonium bromides, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, and the like. An example of a cationic surfactant is SANISOL B-50 available from Kao Corp., which consists primarily of benzyl dimethyl alkonium chloride.

Examples of nonionic surfactants include polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc Inc. as IGEPAL CA-210, IGEPAL CA-520, IGEPAL CA-720, IGEPAL CO-890, IGEPAL CO-720, IGEPAL CO-290, IGEPAL CA-210, ANTAROX 890 and ANTAROX 897. An example of a nonionic surfactant is ANTAROX 897 available from Rhone-Poulenc Inc., which consists primarily of alkyl phenol ethoxylate.

Any suitable emulsion aggregation procedure may be used in forming the emulsion aggregation toner particles without restriction. These procedures typically include the basic process steps of at least aggregating an aqueous latex emulsion containing the binder polymer(s), colorant(s), wax(es), optionally one or more surfactants, coagulant and any additional optional additives to form aggregates, optionally forming a shell on the aggregated core particles, subsequently optionally coalescing or fusing the aggregates, and then recovering, optionally washing and optionally drying the obtained emulsion aggregation toner particles.

An example emulsion/aggregation/coalescing process includes forming a polymer latex, for example comprised of a polyester polymer, forming a polymer latex, for example comprised of a high Mw and low Mw amorphous polyester polymers and crystalline polyester, forming a wax dispersion and forming a colorant dispersion, mixing the high Mw and low Mw amorphous polyester polymers and crystalline polyester, wax dispersion and colorant dispersion. The mixture is stirred, for example using a homogenizer until homogenized, and then transferred to a reactor where the homogenized mixture is heated to a temperature below the Tg of the binder polymers, for example, to at least about 40-45° C., and held at such temperature for a period of time to permit aggregation of toner particles to a desired size. Additional binder latex, high Mw and low Mw amorphous polyester polymers and crystalline polyester mixture, may then be added to form the shell upon the aggregated core particles. Once the desired size of aggregated toner particles is achieved, the pH of the mixture is adjusted in order to inhibit further toner aggregation. The toner particles are further heated to a temperature of, for example, at least about 80-90° C., and the pH lowered in order to enable the particles to coalesce and spherodize. The heater is then turned off and the reactor mixture allowed to cool to room temperature, at which point the aggregated and coalesced toner particles are recovered and optionally washed and dried.

The composite toner particles are, in embodiments, formed by mixing the high Mw and low Mw amorphous polyester latex with a certain quantity of the crystalline polymer latex, in the presence of the wax and the colorant dispersions. The resulting mixture, for example having a pH of about 2 to about 3, is then aggregated by heating to a temperature below the resin Tg of the amorphous polymers to provide particles aggregates. The heating may thus be to a temperature of about 40° C. to about 45° C. Once a desired initial size of aggregates is obtained, additional mixture of high Mw and low Mw amorphous polyester with a certain quantity of crystalline polymer latex is then added to the formed aggregates, this later addition of latex providing a shell over the pre-formed aggregates. Aggregation continues until the shell is of a desired thickness, i.e., the aggregates have formed a desired overall size. The pH of the mixture is then changed, for example by the addition of a sodium hydroxide solution, to about 4-5. At this pH, the carboxylic acid becomes ionized to provide additional negative charge on the aggregates, thereby providing stability and preventing the particles from further growth or an increase in the GSD when heated above the Tg of the latex resin. The temperature is thereafter raised to at least about 80°-90° C., for example at least about 83° C., such as from about 80° C. to about 90° C. After about 30 minutes to a few hours, the pH of the mixture is increased to a value of less than about 58, for example from about 7 to about 8, to coalesce or fuse the aggregates with the heat and to provide the composite particle. The particle may be measured for shape factor or circularity using a Sysmex FPIA 2100 analyzer, and coalescence permitted to continue until a desired shape is achieved. The particles are then allowed to cool to room temperature and optionally washed. In embodiments, the washing includes a first wash conducted at a pH of about 7-8 and at a temperature of about 20-50° C., followed by a deionized water wash at room temperature, followed by a wash at a pH of about 7.2 and at a temperature of about 40° C., followed by a final deionized water wash. The toner is then dried and recovered.

In embodiments, the toner particles are made to have an average particle size of from about 1 to about 15 micrometers, for example from about 2 to about 10 micrometers, such as from about 3 to about 7 micrometers, with a shape factor of from about 120 to about 140 and an average circularity of about 0.90 to about 0.98. The particle size may be determined using any suitable device, for example a conventional Coulter counter. The shape factor and circularity may be determined using a Malvern Sysmex Flow Particle Inage Analyzer FPIA-2100. The circularity is a measure of the particles closeness to a perfect sphere. A circularity of 1.0 identifies a particle having the shape of a perfect circular sphere.

The toner particles of the present disclosure exhibit an average surface hardness of from about 130 mPa to about 250 mPa, an average surface hardness of from about 150 mPa to about 210 mPa, an average surface hardness of from about 170 mPa to about 200 mPa, or an average surface hardness of from about 140 mPa to about 200 mPa.

As used herein, numerical values are often presented in a range format throughout this document. The use of a range format is merely for convenience and brevity and should not be construed as an inflexible limitation on the scope of the invention. Accordingly, the use of a range expressly includes all possible subranges, all individual numerical values within that range, and all numerical values or numerical ranges including integers within such ranges and fractions of the values or the integers within ranges unless the context clearly indicates otherwise.

It will be appreciated that varies of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

### Preparation of Toner

Experimental toner (Sample 1): EA Ultra Low Melt (EA-Eco) Magenta Particle with crystalline polyester latex in both Core and Shell

In a 20-gallon reactor was combined 14 parts Latex A (High molecular weight polyester amorphous latex, e.g., poly-(propoxylated bisphenol-A-ethoxylated bisphenol-A-terephthalate-dodecenylsuccinate-trimellitate), at solids content 35 wt %), 14 parts Latex B (low molecular weight polyester amorphous latex, e.g., poly-(propoxylated bisphenol-A-terephthalate-dodecenylsuccinate-fumarate), at solids content 35 wt % made by solvent free process), 4.7 parts Latex C (crystalline polyester latex, e.g., poly-(1,9-nonane diol-1,10-dodecane dicarboxylate), at solids content 30 wt %), at solids content 30 wt %), 5.8 parts Wax (at solids content 30 wt %), pigment dispersions PR122 (4.5 wt. % by weight of toner)) and PR269 (4.5 wt. % by weight of toner, and 47 parts DI water. This solution was adjusted to a pH of about 4.2 using 0.3M HNO₃ acid. To this solution was added under homogenization at 2,000 RPM, 1.0 parts of a 10% by weight aluminum sulphate solution in water over a period of 5 minutes. The reactor was then stirred at about 50 RPM and was heated to about 48° C. to aggregate the toner particles.

Crystalline Polyester in Shell of Particles and Process:

When the size reaches 5.0 μm, a shell coating was added which includes 7.6 parts Latex A, 7.6 parts Latex B, 4.7 parts Latex C, 0.1 parts Dowfax surfactant, and 100 parts DI water. The reaction was heated to 50° C. When the toner particle size reached 5.8 μm, the pH was adjusted to 5.0 using a 4% NaOH solution. The reactor RPM was then decreased to 45 RPM, followed by the addition of 0.7 part of EDTA Versene 100. The pH was then adjusted and maintained at 7.5 and the toner slurry was heated to the coalescence temperature 85° C. When the coalescence temperature was reached, the pH was lowered to a value of about 7.3 to allow spheroidization (coalescence) of the toner. After about 1.5 to 3.0 hours when the desired circularity of about 0.964 was obtained, the toner was “quenched” to less than 45° C. through a heat exchanger. After cooling, the toners were washed to remove any residual surfactants and ions and dried to the moisture content below 1.2 wt %.

Control toner (Sample 2): EA Ultra Low Melt (EA-Eco) Magenta Particle with crystalline polyester latex in core only

Crystalline Polyester in Core of Particles and Process:

In a 20-gallon reactor are combined 14 parts Latex A, 14 parts Latex B, 4.7 parts Latex C, 5.8 parts Wax (at solids content 30 wt %), pigment dispersions PR122 (4.5 wt. % by weight of toner) and PR269 (4.5 wt. % by weight of toner), and 47 parts deIonized (DI) water. The resulting solution was adjusted to a pH of about 4.2 using 0.3M HNO₃ acid. To this solution was added, under homogenization at 2,000 RPM, 1.0 parts of a 10% by weight aluminum sulphate solution in water over a period of 5 minutes. The reactor was then stirred at about 50 RPM and is heated to about 48° C. to aggregate the toner particles.

Shell of Particles and Process:

When the size reaches 5.0 μm, a shell coating was added which consists of 7.6 parts Latex A, 7.6 parts Latex B, 0.1 parts Dowfax surfactant, and 100 parts deIonized (DI) water. The reaction is heated to 50° C. When the toner particle size reaches 5.8 μm, the pH is adjusted to 5.0 using a 4% NaOH solution. The reactor RPM is then decreased to 45 RPM, followed by the addition of 0.7 part of EDTA Versene 100. The pH is then adjusted and maintained at 7.5 and the toner slurry is heated to the coalescence temperature 85° C. When the coalescence temperature is reached, the pH is lowered to a value of about 7.3 to allow spheroidization (coalescence) of the toner. After about 1.5 to 3.0 hours when the desired circularity of about 0.964 is obtained, the toner is “quenched” to less than 45° C. through a heat exchanger. After cooling, the toners are washed to remove any residual surfactants and ions and dried to the moisture content below 1.2 wt %.

### Example 2

### Analysis of Toner

The toners were analyzed for particle surface hardness, tribo, fusing Minimum Fix Temperature (MFT) (i.e., minimum. temperature that toner starts to fuse), gloss level, glass transition temperature (Tg), and heat cohesion onset temperature.

Measurement of Hardness: The hardness test was performed using a conical 2 micron diamond tip. The surfaces were indented nine times with indents spaced 8 microns apart to 500 nm at a strain rate of 0.05/sec and frequency of 45 Hz. The Poisson's ratio was assumed to be 0.4. Poisson's ratio is the ratio of transverse contraction strain to longitudinal extension strain in the direction of stretching force and typically positive. For polymeric materials the Poisson's ratio is typically between 0.31-0.35. Rubbers are closer to 0.5. Metals and ceramics are closer to 0.2-0.1.

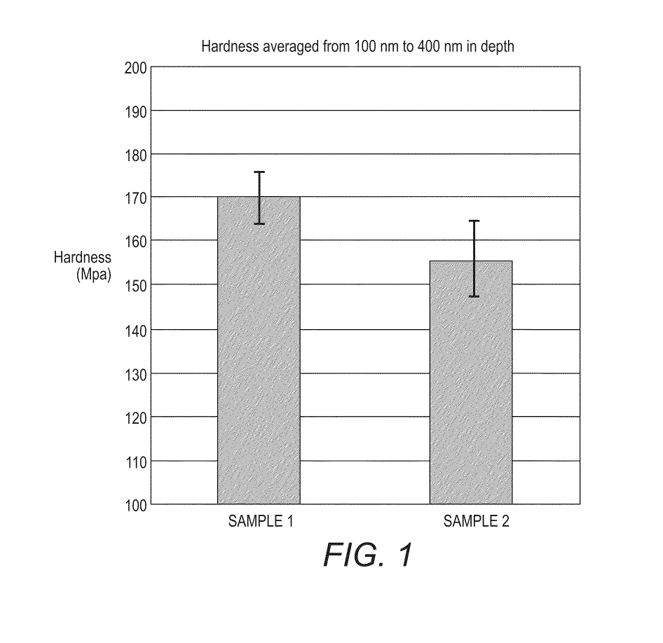

The surface hardness of the toner particles was calculated from the instantaneous load and the tip shape at the depth of the penetration from the load displacement curves. Typically Hardness is calculated as Hardness=Load/projected Area. During an indentation the applied load on the indenter and resulting depth of penetration can be measured instantaneously as the indenter is penetrating the sample surface. The indenter creates an impression in the surface that reflects the shape of the indentation tip shape. The projected area of this impression can be calculated by knowing a mathematical expression of the geometry of the indenter shape (tip shape) and how deep the indenter penetrated (penetration depth). Hence the surface hardness can be calculated by the instantaneous applied load divided by the calculated projected area known from the tip area function and the instantaneous depth of penetration. FIG. 1 shows the average calculated surface hardness (MPa) for toner particles of Experiment Toner and Control Toner.

Table 1 below shows the data of the toner surface hardness for Experiment Toner Sample 1 and Control Toner Sample 2. The toner particles of Experimental Toner demonstrate 9-14 MPa higher strength than that of Control Toner, and 0.5-0.6 GPa higher in average elastic modulus than Control Toner particle. Control Toner particles contain amorphous latex and with no crystalline polyester in the shell. ExperCrystalline latex exhibits much higher mechanical strength below its melting point unlike amorphous polyester that has not melting point.

TABLE 1

| | E Average | | | H Average | | |
|---|---|---|---|---|---|---|
| | Over Defined | | | Over Defined | | |
| | Range | st | % | Range | st | % |
| Particle | GPa | dev | COV | MPa | dev | COV |
| Sample | 2.71 | 0.052 | 1.9 | 170 | 6 | 3.5 |
| 1 | | | | | | |
| Sample | 2.65 | 0.142 | 5.4 | 156 | 9 | 5.8 |
| 2 | | | | | | |

“% COV” is the standard deviation/average.
“E average over defined range” is the average elastic modulus from 100 nm to 400 nm, modulus was averaged over 6-9 indentations.
“H average over defined range” is the average hardness from 100 to 400 nm in depth, averaged over 6-9 indentations.

A t-test has been conducted to compare the surface hardness between Sample 1 and Sample 2. The results showed that the surface hardness of Sample 1 was significantly higher than that of Sample 2.

Tribo (Triboelectric Charge) and Blocking Temperature: The toner blocking temperature test was completed. The results showed that the onset blocking temperature for Experimental Toner Sample 1 was 1.5° C. higher (better) than Control Toner Sample 2. Table 2 below summarizes the properties of the toner samples.

TABLE 2

| | MFI | | | | Particle | Toner | Toner | | Blocking |
|---|---|---|---|---|---|---|---|---|---|
| | (115° C./5 kg) | Shimadzu (° C.) | | | tribo/At | Azone | Jzone | | onset |
| Sample ID | (g/10 minut) | Ts | Tfb | T½ | (Bzone) | tribo | tribo | J/A ratio | temp. |
| Sample 1 | 12.8 | 58.6 | 74.9 | 96 | 50/590 | 33 | 61 | 1.8 | 54 |
| Sample 2 | 12.6 | 59 | 74.8 | 95.8 | 53/605 | 29 | 63 | 2.2 | 52.5 |

Table 3 below shows toner behavior from Tribo. Experimental Toner Sample 1: shows no difference in all zones than Control Toner Sample 2. After 10 minutes of shaking, it was observed that no shift in AT with Sample 1, but a shift of 20 AT units in Sample 2. AT is a calculated Tribo value with respect to toner concentration. The Tribo values are generally different based on the toner concentration in the developer. From previous studies on the zero throughput, AT only amplifies with higher toner ages.

Table 3 also shows Admix data with no changes of toner after 10 minute paint shake. This shows that there should be no issues with adding the crystalline polyester to the shell for charging.

TABLE 3

| | | Tribo | | AT | | |
|---|---|---|---|---|---|---|
| | | A | J | B zone - | B zone - | |
| Toner | Particle | zone | zone | initial | 10 min | Delta |
| Sample 1 | 105M | 35.79 | 60.96 | 518 | 519 | 1 |
| Sample 2 | 106M | 38.15 | 59.89 | 496 | 516 | 19 |

Admix is to create the charge spectrograph of toner. 30 grams of carrier into an 8 ounce jar and then add 2.4 grams of toner (yield a TC of 8%) mixed in a paint shaker at 715 CPM for 10 minutes. After 10 minute paint shake 2.5 gram of sample has taken and blow-off through the charge spectrograph device. This provides initial charge spectrograph. Subsequently 1.2 gram of toner was added in the paint shaker and paint shake 15 sec, 30 sec and 60 sec. To evaluate the freshness of the toner blend with the incumbent toner, a toner sample was removed from the charge spectrograph device at each of the paint shake time slot for subsequent charge spectrograph. When two peaks are shown on a charge spectrograph, it indicates charge through (i.e., blend with incumbent toner too fast) or slow admix (i.e., blend with incumbent toner too slow). Accordingly, having a single peak in the charge spectrograph is ideal. The results of admix with experimental toners are the same as compared to the control showing single peaks throughout the time intervals.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

1. A toner particle having an increased surface hardness comprising a core surrounded by a shell, wherein the shell comprises a first crystalline resin, wherein the shell has a thickness of from about 0.2 μm to about 1.5 μm, further wherein the toner particle has an average surface hardness of from about 130 mPa to about 250 mPa.

2. The toner particle of claim 1, wherein the first crystalline resin has a weight average molecule weight of from about 2,000 to about 100,000.

3. The toner particle of claim 1, wherein the first crystalline resin comprises polyester.

4. The toner particle of claim 3, wherein the polyester is selected from the group consisting of poly(ethylene-adipate), polypropylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), alkali copoly(5-sulfoisophthaloyl)-copoly(ethylene-adipate), poly(decylene-sebacate), poly(decylene-decanoate), poly-(ethylene-decanoate), poly-(ethylene-dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), and mixtures thereof.

5. The toner particle of claim 1, wherein the first crystalline resin is present in an amount of from about 15% to about 35% based on the total weight of the shell.

6. The toner particle of claim 1, wherein the shell further comprises a first amorphous resin.

7. The toner particle of claim 5, wherein the weight ratio of the first crystalline resin to first amorphous resin in the shell is from about 1:99 to about 30:70.

8. (canceled)

9. The toner particle of claim 1, wherein the core comprises a second crystalline resin and a second amorphous resin.

10. The toner particle of claim 9, wherein the second crystalline resin is present in an amount of from about 10% to about 20% based on the total weight of the core.

11. The toner particle of claim 1, wherein the second crystalline resin is the same as the first crystalline resin.

12. The toner particle of claim 1, wherein the second crystalline resin is different from the first crystalline resin.

13. The toner particle of claim 9, wherein the weight ratio of the second crystalline resin to second amorphous resin in the core is from about 1:99 to about 30:70.

14. The toner particle of claim 1, wherein the toner particle has an average diameter of from about 1 micrometer to about 15 micrometers.

15. The toner particle of claim 1, wherein the toner particle is an emulsion aggregation toner particle.

16. A toner particle having an increased surface hardness comprising a core surrounded by a shell, wherein the shell comprises a first crystalline polyester resin present in an amount of from about 15% to about 35% based on the total weight of the shell, and the core comprises a second crystalline polyester resin present in an amount of from about 10% to about 20% based on the total weight of the core, wherein the first crystalline polyester resin and the second crystalline polyester resin are the same, wherein the shell has a thickness of from about 0.2 μm to about 1.5 μm, and further wherein the toner particle has an average surface hardness of from about 130 mPa to about 250 mPa.

17. A toner composition comprising
a toner particle having an increased surface hardness; and
a colorant;
wherein the toner particle comprising a core surrounded by a shell, wherein the shell comprises a first crystalline resin, wherein the shell has a thickness of from about 0.2 μm to about 1.5 μm, wherein the toner particle has an average surface hardness of from about 130 mPa to about 250 mPa.

18. The toner composition of claim 17, wherein the first crystalline resin is present in an amount of from about 15% to about 35% based on the total weight of the shell.

19. The toner composition of claim 17, wherein the shell further comprises a first amorphous resin, and further wherein the core comprises a second crystalline resin and a second amorphous resin.

20. The toner composition of claim 17, wherein the first crystalline resin comprises a polyester resin.
